(19) United States
(12) Patent Application Publication
(10) Pub. No.: US 2010/0091009 A1
(43) Pub. Date: Apr. 15, 2010

(54) Display driving circuit and test method

(75) Inventor: Yoshinori Uchiyama, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/585,438

(22) Filed: Sep. 15, 2009

(30) Foreign Application Priority Data
Oct. 14, 2008 (JP) 2008-264765

(51) Int. Cl. G09G 5/00

(52) U.S. Cl. 345/214

(57) ABSTRACT

A display driving circuit according to an exemplary embodiment of the present invention includes: a plurality of driver circuits; a display control logic circuit that controls the plurality of driver circuits; and a first selector that selects one of a video input signal externally received and an internal operation signal from the display control logic circuit, and supplies the selected signal to each of the plurality of driver circuits.

### BACKGROUND

1. Field of the Invention

The present invention relates to a display driving circuit and a test method, and more particularly, to a display driving circuit including a test circuit, and a test method.

2. Description of Related Art

In recent years, the prices of liquid display devices such as LCD televisions have been greatly reduced, and the price reduction affects the prices of display drive control LSIs for use in the display devices. Meanwhile, a leak current or the like is increased due to miniaturization of the display drive control LSIs, and the number of items for evaluation using a tester and shipping inspection is increased, resulting in an increase in test time. As a result, a test cost accounts for a large portion of the cost of each display drive control LSI, and therefore, there is an increasing demand for a reduction in test time.

In this regard, various display drive control LSIs including a test circuit have been proposed (see Japanese Unexamined Patent Application Publication Nos. 2000-147057 (Maeda), 2000-19480 (Tachibana), 2004-126435 (Monda), and 2004-325978 (Miyata)). Referring now to FIG. 6, the configuration of the test circuit of the related art disclosed by Maeda will be described. FIG. 6 is a diagram showing the configuration of the test circuit disclosed by Maeda. An ASIC 20 serving as a test circuit includes a selector circuit 21, a RAM 22, an internal logic circuit 23, a D/A converter circuit 24, and an analog switch 25. The analog switch 25 is a switching circuit for switching between an analog test signal and an internal signal.

During a test operation, the ASIC 20 is connected to an external tester (not shown) through external input pins and external output pins of the ASIC 20. The ASIC 20 receives a test pattern and a digital test signal, which are used for testing the RAM 22 from the external tester, and outputs the analog test signal through the D/A converter circuit 24.

During a normal operation of the ASIC 20, the selector circuit 21 transfers the internal signal of the internal logic circuit 23 to data input pins DIn to DI0 of the RAM 22. Meanwhile, during the test operation, the selector circuit 21 transfers the digital test signal received from the external input pins of the ASIC 20. The selector circuit 21 normally selects the internal signal. Upon receiving a select signal, the selector circuit 21 selects the digital signal. The select signal is, for example, directly supplied to the external tester through the external input pins of the ASIC 20.

The D/A converter circuit 24 converts the digital test signal, which is output from each of data output pins DOn to DO0 of the RAM 22 and is input to each of input pins Bn to B0 for receiving the digital signal, into the analog test signal, and outputs the analog test signal from an output pin AOUT for outputting the analog signal. The test signal in the RAM 22 is composed of a binary signal indicating “1” or “0”. The test signal converted into the analog signal by the D/A converter circuit 24 is a test signal composed of a multilevel signal.

The analog switch 25 transfers the internal signal, which is output from the internal logic circuit 23, to one external output pin of the ASIC 20, for example, during the normal operation of the ASIC 20. Meanwhile, during the test operation, the analog switch 25 transfers the analog test signal output from the D/A converter circuit 24. The analog switch 25 is configured to normally select the internal signal and to select the analog test signal according to the select signal input to the selector circuit 21.

During the normal operation of the ASIC 20, the RAM 22 outputs the internal signal to the internal logic circuit 23 from the data output pins DOn to DO0. The RAM 22 includes input pins Am to A0 for receiving an address signal, an input pin WE for receiving a write enable signal, and an input pin CE for receiving a chip enable signal. During the normal operation of the ASIC 20, the RAM 22 outputs the internal signal from the data output pins DOn to DO0 to the internal logic circuit 23.

Next, the test operation of the ASIC 20 configured as described above will be described. The external input pins and the external output pins of the ASIC 20 are each connected to the external tester. During the test operation for the RAM 22, the digital test signal composed of an input test pattern of a single RAM 22 is output from the external tester. The test signal is input to the ASIC 20 through a number of external input pins of the ASIC 20 corresponding to the number of bits of the test signal. The digital test signal input to the ASIC 20 is transmitted to the RAM 22 through the selector circuit 21. In this case, the selector circuit 21 is configured to select the test select signal instead of the internal signal, according to the select signal.

The digital test signal transferred to the RAM 22 is temporarily written into an address specified by an address signal (not shown) of the RAM 22, and is then read and transferred to the D/A converter circuit 24. The digital test signal is converted into the analog test signal by the D/A converter circuit 24. After that, the analog test signal is transferred to the analog switch 25. The analog switch 25 is configured to select the test signal instead of the internal signal, according to the select signal, and to supply the selected test signal to, for example, one external output pin of the ASIC 20. The external tester compares the analog test signal output from the ASIC 20 with an expectation value, thereby determining whether the RAM 22 is defective or not.

During the test operation for the RAM 22, the digital test signal composed of a binary signal is output from the RAM 22. The D/A converter circuit 24 converts the output test signal into the analog test signal composed of a multilevel signal. Then, the analog switch 25 switches between the test signal converted into the analog signal and the internal signal, and outputs the switched signal from the external output pin of the ASIC 20. Accordingly, only one external output pin, for example, is required to output the test signal of the RAM 22 to the external tester. Therefore, the test circuit can be connected to the external tester with a small number of external output pins.

### SUMMARY

In the related art shown in FIG. 6, it is necessary to additionally provide a D/A converter circuit to convert the digital test signal composed of a binary signal into the analog test signal composed of a multilevel signal, for one external output pin, and to provide an analog switch for switching between an internal signal and an analog test signal. This results in a significant increase in chip area. In the case of connecting a test circuit to an external tester to start a test, the characteristics (e.g., resolution and linearity) of the D/A converter circuit incorporated in the test circuit are evaluated in most cases.

Further, it is necessary to repeat plural times a series of processes in which data is sent to the D/A converter circuit by switching the signal to the internal signal and a test is started at the time when the D/A converter circuit outputs an output value. This causes a problem of an increase in test time.

A first exemplary aspect of the present invention is a display driving circuit including: a plurality of driver circuits; a control circuit that controls the plurality of driver circuits; and a first selector that selects one of a video input signal externally received and an internal operation signal from the control circuit, and supplies the selected signal to each of the plurality of driver circuits. With such a simple circuit configuration including the selector, the internal operation signal of the control circuit can be extracted from the driver circuits, thereby making it possible to easily carry out a test. Further, an increase in costs and chip area can be suppressed.

A second exemplary aspect of the present invention is a test method for a display driving circuit including a plurality of driver circuits and a control circuit that controls the plurality of driver circuits, the method including: supplying a video input signal externally received to each of the plurality of driver circuits through a selector, during a normal operation; and switching the video input signal to an internal operation signal of the control circuit, and supplying the internal operation signal to each of the plurality of driver circuits through the selector, during a test mode. According to the second aspect of the present invention, the internal operation signal of the control circuit can be extracted from the driver circuits, thereby making it possible to easily carry out a test.

According to exemplary aspects of the present invention, it is possible to provide a display driving circuit and a test method that are capable of easily performing a test and suppressing an increase in costs and chip area.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing a configuration of a liquid-crystal-display drive control LSI including a test circuit according to a first exemplary embodiment of the present invention;

FIG. 2 is a diagram showing a configuration of a driver circuit for use in the liquid-crystal-display drive control LSI according to the first exemplary embodiment;

FIG. 3 is a timing diagram illustrating operation of the liquid-crystal-display drive control LSI including the test circuit according to the first exemplary embodiment;

FIG. 4 is a flowchart illustrating operation of the liquid-crystal-display drive control LSI including the test circuit according to the first exemplary embodiment;

FIG. 5 is a diagram showing a configuration of a liquid-crystal-display drive control LSI including a test circuit according to a second exemplary embodiment of the present invention; and

FIG. 6 is a diagram showing a configuration of a test circuit according to the related art.

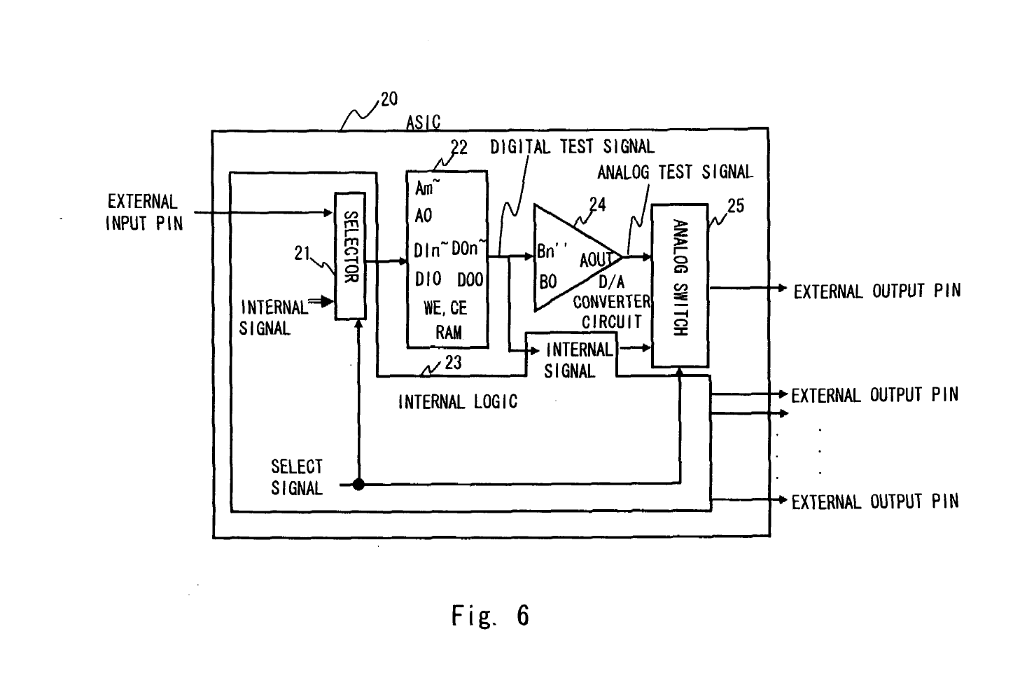

### DETAILED DESCRIPTION OF THE EXEMPLARY EMBODIMENTS

### First Exemplary Embodiment

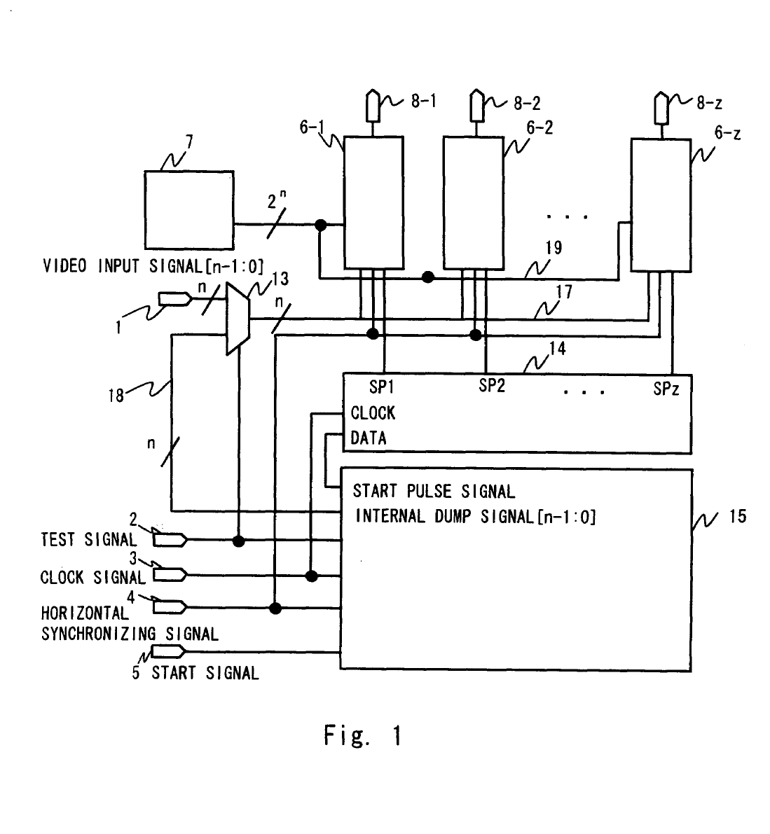

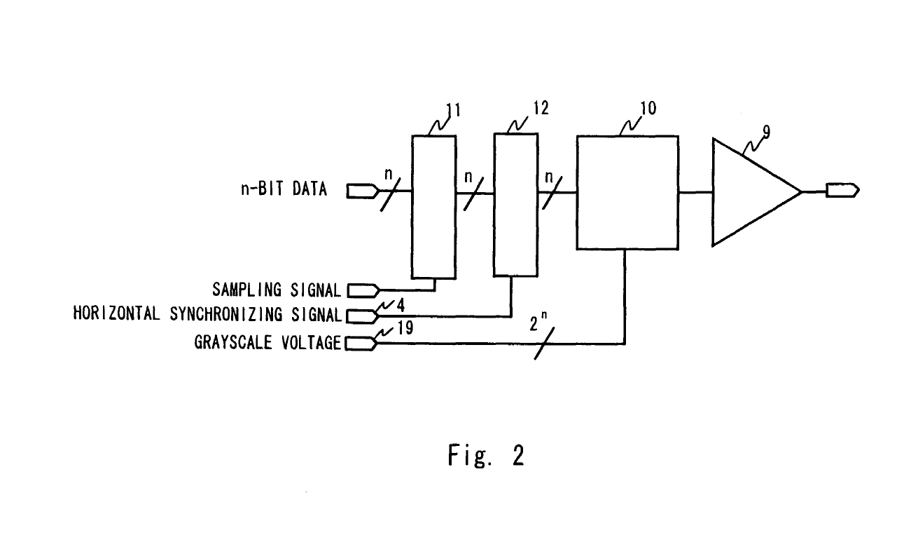

Referring to FIGS. 1 and 2, description is made of a test circuit for a liquid-crystal-display drive control LSI according to a first exemplary embodiment of the present invention. FIG. 1 is a diagram showing the configuration of the liquid-crystal-display drive control LSI including the test circuit according to this exemplary embodiment. FIG. 2 is a diagram showing an example of driver circuits for use in the liquid-crystal-display drive control LSI according to this exemplary embodiment. The liquid-crystal-display drive control LSI according to this exemplary embodiment has a normal operation period for outputting a grayscale voltage according to a video input signal, and a test mode period.

As shown in FIG. 1, the liquid-crystal-display drive control LSI according to this exemplary embodiment includes a video input signal terminal 1, a test signal terminal 2, a clock signal terminal 3, a horizontal synchronizing signal terminal 4, a start signal terminal 5, driver circuits 6-1 to 6-z, grayscale voltage generating circuit 7, driver output terminals 8-1 to 8-z, a first selector 13, a shift register 14, a display control logic circuit 15, an internal data bus line 17, an internal dump signal line 18, and grayscale voltage lines 19.

The video input signal terminal 1 is connected to the first selector 13. The first selector 13 receives a video input signal from the video input signal terminal 1. The test signal terminal 2 is connected to each of the first selector 13 and the display control logic circuit 15. Each of the first selector 13 and the display control logic circuit 15 receives a test signal from the test signal terminal 2. The term “test signal” refers to a signal for setting the liquid-crystal-display drive control LSI to a test mode. In this exemplary embodiment, it is assumed that the period in which the test signal is set to High level is defined as the test mode period, and the period in which the test signal is set to Low level is defined as the normal operation period.

The clock signal terminal 3 is connected to each of the shift register 14 and the display control logic circuit 15. Each of the display control logic circuit 15 and the shift register 14 receives a clock signal from the clock signal terminal 3. The horizontal synchronizing signal terminal 4 is connected to the display control logic circuit 15 and each of the driver circuits 6-1 to 6-z. The display control logic circuit 15 and the driver circuits 6-1 to 6-z each receive a horizontal synchronizing signal from the horizontal synchronizing signal terminal 4.

The start signal terminal 5 is connected to the display control logic circuit 15. The display control logic circuit 15 receives a start signal from the start signal terminal 5. The display control logic circuit 15 outputs a start pulse signal to the shift register 14. The term “start pulse signal” refers to a signal for starting a shift operation of the shift register 14.

The shift register 14 according to this exemplary embodiment uses the start pulse signal, which is received from the display control logic circuit 15, as data, and performs an operation for sequentially outputting pulses of sampling signals SP1 to SPz according to the clock signal. The sampling signals SP1 to SPz from the shift register 14 are respectively input to the driver circuits 6-1 to 6-z.

The grayscale voltage generating circuit 7 outputs 2n voltage values of grayscale voltages V1 to V2n. The driver circuits 6-1 to 6-z are respectively connected to the 2n grayscale voltage lines 19 of the grayscale voltage generating circuit 7, and are each supplied with a grayscale voltage. Further, the driver circuits 6-1 to 6-z are each connected to the internal data bus line 17. The outputs of the driver circuits 6-1 to 6-z are respectively connected to the drive output terminals 8-1 to 8-z. Note that the configuration of each of the driver circuits 6-1 to 6-z will be described in detail below.

The first selector 13 switches between an internal dump signal for use in the test mode and the video input signal for use in the normal operation, and outputs one of the signals. The term “internal dump signal” refers to an internal operation signal of an internal logic circuit of the display control logic circuit 15. One input terminal of the first selector 13 is connected to the video input signal terminal 1 to receive an n-bit video input signal. Another input terminal of the first selector 13 is connected to the internal dump signal line 18 to receive an n-bit internal dump signal. An output terminal of the first selector 13 is connected to the internal data bus line 17.

In other words, the first selector 13 outputs one of the n-bit video input signal and the n-bit internal dump signal to each of the driver circuits 6-1 to 6-z depending on whether the LSI is in the test mode period or in the normal operation period. That is, the video input signal is transmitted through the internal data bus line 17 during the normal operation, and the signal transmitted through the internal data bus line 17 is switched to the internal dump signal during the test mode.

As shown in FIG. 2, each of the driver circuits 6-1 to 6-z includes a driver circuit 9, a grayscale selection switch 10, a first n-bit latch 11 having an n-bit width, and a second n-bit latch 12 having an n-bit width.

The first n-bit latch 11 receives n-bit data from the internal data bus line 17. Specifically, the first n-bit latch 11 receives the n-bit video input signal during the normal operation period, and receives the n-bit internal dump signal during the test mode period. Further, the first n-bit latches 11 of the driver circuits 6-1 to 6-z respectively receive, from the shift register 14, the sampling signals SP1 to SPz as clocks for latching data.

The second n-bit latch 12 is provided on the output side of the first n-bit latch 11. The second n-bit latch 12 receives the output from the first n-bit latch 11. The second n-bit latch 12 further receives the horizontal synchronizing signal from the horizontal synchronizing signal terminal 4 as a clock. When the horizontal synchronizing signal rises, the data held in the first n-bit latches 11 of the driver circuits 6-1 to 6-z are collectively output to the second n-bit latches 12.

The grayscale selection switch 10 is provided on the output side of the second n-bit latch 12. The grayscale selection switches 10 of the driver circuits 6-1 to 6-z receive the output from the second n-bit latch 12, and respectively receive 2n grayscale voltages from the grayscale voltage generating circuit 7. The output of the grayscale selection switch 10 is input to the driver circuit 9. The outputs of the driver circuits 9 of the driver circuits 6-1 to 6-z are respectively input to the drive output terminals 9-1 to 8-z.

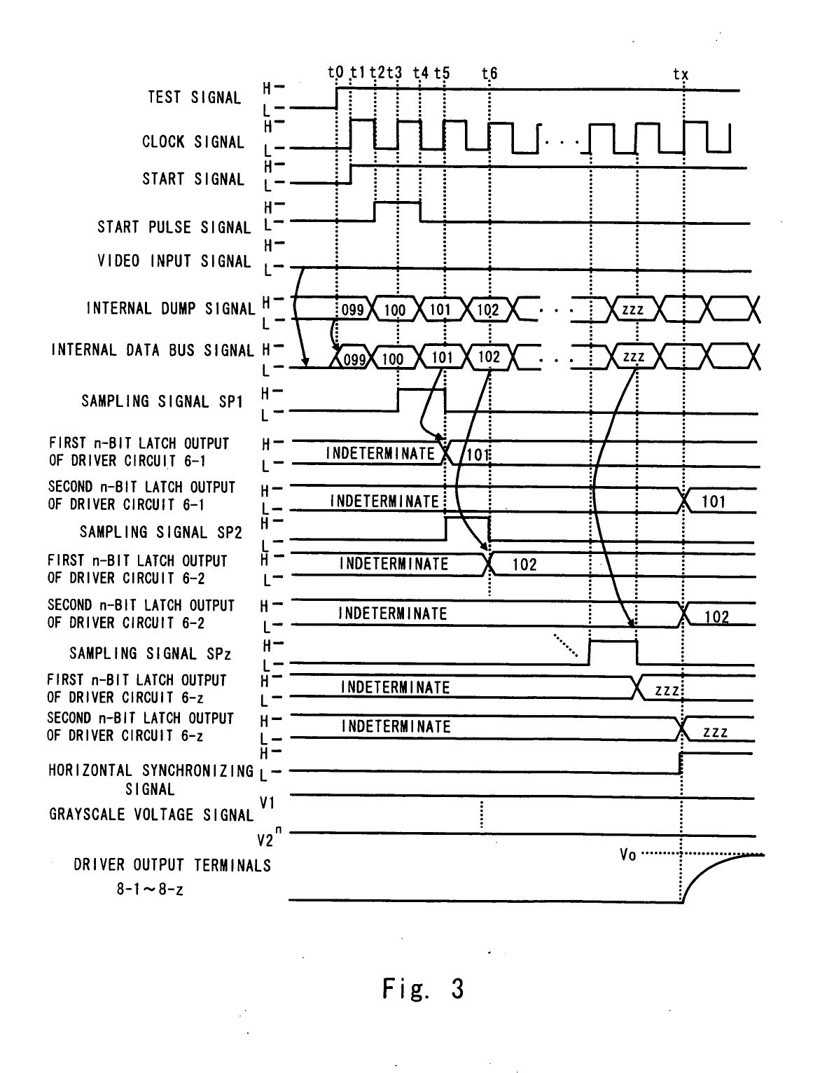

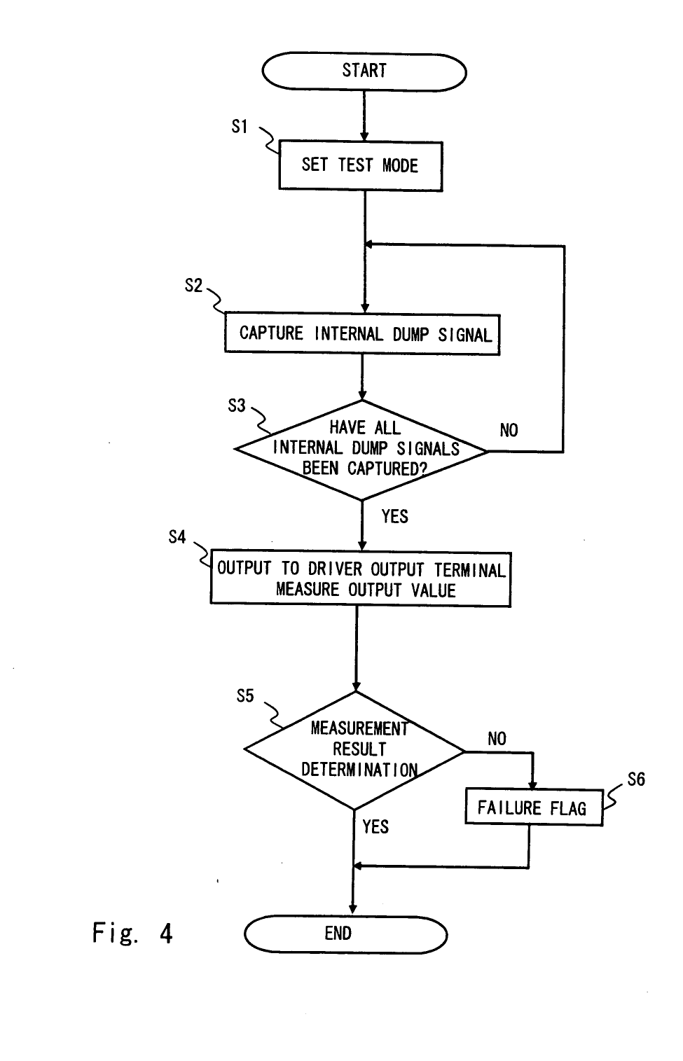

Referring now to FIGS. 3 and 4, description is made of operation of the liquid-crystal-display drive control LSI according to this exemplary embodiment. FIG. 3 is a timing diagram illustrating the operation of the test circuit of the liquid-crystal-display drive control LSI according to this exemplary embodiment. FIG. 4 is a flowchart illustrating the operation of the test circuit of the liquid-crystal-display drive control LSI according to this exemplary embodiment.

First, the liquid-crystal-display drive control LSI is set to the test mode (S1 of FIG. 4). As shown in FIG. 3, the test signal is set to High level at a time t0. In this exemplary embodiment, the period in which the test signal is set to High level corresponds to the test mode period. During the test mode period, the n-bit video input signal from the video input signal terminal 1 is fixed at Low level. Meanwhile, the period in which the test signal is set to Low level corresponds to the normal operation period. During the normal operation period, the grayscale voltage according to the received video input signal is output from each of the driver circuits 6-1 to 6-z.

At a time t1, the start signal from the start signal terminal 5 becomes High level. At the time t2 after the time t1, the start pulse signal becomes High level. After that, at a time t4 when the clock signal falls, the start pulse signal becomes Low level. The start pulse signal is output to the shift register 14 from the display control logic circuit 15, whereby the shift operation is started.

The shift register 14 according to this exemplary embodiment uses the start pulse signal, which is received from the display control logic circuit 15, as data, and performs the operation for sequentially outputting pulses of the sampling signals SP1 to SPz according to the clock signal.

The internal dump signal from the display control logic circuit 15 is synchronized with the falling edge of the clock signal and changed to data representing “099”, “100”, “101”, . . . . The video input signal is transmitted through the internal data bus line 17 during the normal operation, and the signal transmitted through the internal data bus line 17 is switched to the internal dump signal at the time t0 of the test signal during the test mode. Accordingly, during the period in which the test signal is set to High level, the internal dump signal is output from the first selector 13 to the internal data bus line 17.

Then, the internal dump signal is captured (S2 of FIG. 4). Capturing the internal dump signal means that the data from the internal data bus line 17 shown in FIG. 1 are held in the driver circuits 6-1 to 6-z. The waveforms of the second n-bit latch outputs of the driver circuits 6-1 to 6-Z shown in FIG. 3 correspond to the waveforms of the captured data. Specifically, the sampling signal SP1 rises at a time t3 and falls at a time t5. At the time t5 when the sampling signal SP1 falls, the n-bit internal dump signal is held in the first n-bit latch 11 of the driver circuit 6-1.

After that, it is determined whether all the internal dump signals have been captured (S3 of FIG. 4). In the case where all the internal dump signals have not been captured yet (NO in S3 of FIG. 4), the step of capturing the internal dump signal is executed again (S2 of FIG. 4). After the internal dump signal is captured according to the sampling signal SP1, the internal dump signal is started to be captured according to the sampling signal SP2. Specifically, the sampling signal SP2 rises at the time t5 and falls at a time t7. At the time t7 when the sampling signal SP2 falls, the n-bit internal dump signal is held in the first n-bit latch 11 of the driver circuit 6-2.

The above-mentioned operation is repeatedly performed for all the sampling signals SP1 to SPz, with the result that the n-bit internal dump signal is held in each of the first n-bit latches 11 of the driver circuits 6-1 to 6-z. In the case where all the internal dump signals have been captured (YES in S3 of FIG. 4), the internal dump signals are then output to the drive output terminals 9-1 to 8-z to measure an output voltage value (S4 of FIG. 4). Specifically, when the horizontal synchronizing signal rises at a time tx, the data held in the first n-bit latches 11 of the driver circuits 6-1 to 6-z are collectively output to the second n-bit latches 12.

The 2n voltage values of the grayscale voltages V1 to V2n shown in FIG. 3 are output from the grayscale voltage generating circuit 7. The grayscale voltage V1 represents High level, and V2n represents Low level. Note that the term “grayscale voltage” refers to a voltage value representing the brightness of a liquid crystal display device in a liquid-crystal-display drive control LSI. The 2n grayscale voltages from the grayscale voltage generating circuit 7 are input to the grayscale selection switch 10. The grayscale selection switch 10 selects a grayscale voltage Vo according to the output from the second n-bit latch 12. Then, the selected grayscale voltage Vo is output from the driver circuit 9 through the drive output terminals 9-1 to 8-z.

After that, the measured output voltage value is compared with the upper limit and lower limit of a preset reference value, thereby determining the measurement result (S5 of FIG. 4). Then, when the measured output voltage value falls out of the range between the upper limit and the lower limit of the reference value (NO in S5 of FIG. 4), a failure flag is set (S6). On the other hand, when the measured output voltage value falls within the range between the upper limit and lower limit of the reference value, the test is finished.

As described above, the internal dump signals of the display control logic circuit of the liquid-crystal-display drive control LSI are extracted to the outside from the driver circuits 6-1 to 6-z which are respectively connected to the drive output terminals 9-1 to 8-z. Accordingly, the test circuit can be realized with a simple circuit configuration including the first selector 13 for switching between the internal dump signal for use in the test operation and the video input signal output from each of the driver circuits 6-1 to 6-z during the normal operation.

Further, the internal dump signals are sequentially latched to the plurality of driver circuits 6-1 to 6-z which incorporate the grayscale selection circuits depending on the number of grayscales (e.g., 256 grayscales (8 bits) or 1024 grayscales (10 bits)) of display data, and the data is output at a given timing after all the latch operations are completed, thereby performing tests at one time. Accordingly, according to an exemplary embodiment of the present invention, it is only necessary to make a single determination.

In the related art, the test is repeatedly performed the necessary number of times, while internal signals accumulated in a RAM are read as digital test signals from the RAM. Thus, it is necessary to carry out a process for making a determination as to defective/non-defective the number of times corresponding to the number of tests. This causes a problem of an increase in the number of times of determination and an increase in test time. Meanwhile, according to an exemplary embodiment of the present invention, it is only necessary to make a single determination, which results in a reduction in test time.

### Second Exemplary Embodiment

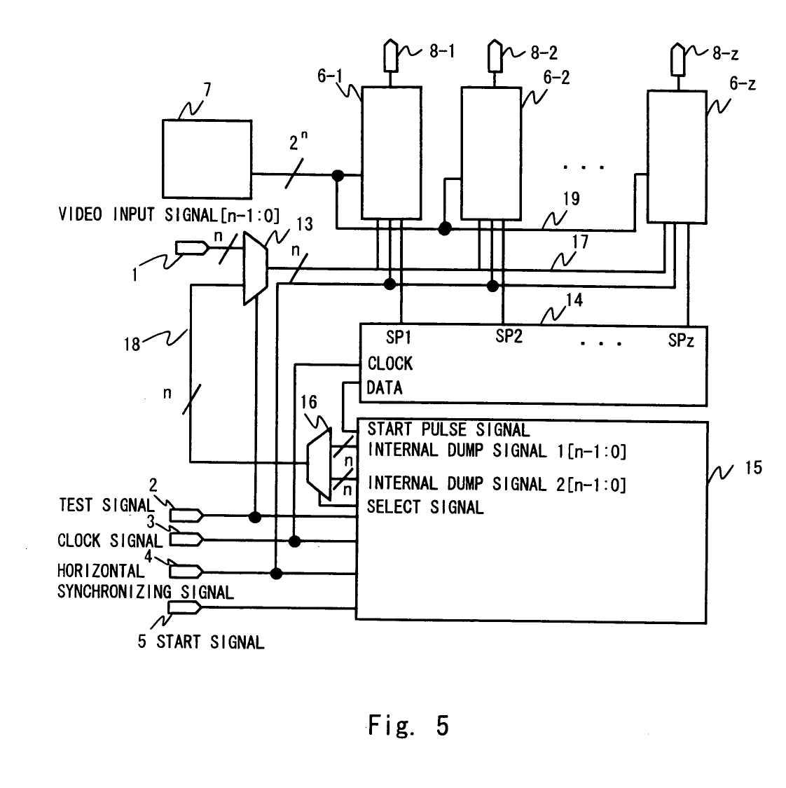

Referring now to FIG. 5, description is made of a test circuit for a liquid-crystal-display drive control LSI according to a second exemplary embodiment of the present invention. FIG. 5 is a diagram showing the configuration of the liquid-crystal-display drive control LSI including the test circuit according to this exemplary embodiment. In this exemplary embodiment, a second selector 16 for extracting the internal dump signals of the display control logic circuit 15 is added to the configuration of the first exemplary embodiment. Note that components of FIG. 5 which are identical with those of FIG. 1 are denoted by the same reference symbols, and the description thereof is omitted.

An input of the second selector 16 is connected to the display control logic circuit 15, and an output of the second selector 16 is connected to the input side of the first selector 13. In this exemplary embodiment, it is assumed that when the internal dump signal of the display control logic circuit 15 has an m-bit width for the internal data bus line 17 of n-bit width, for example, the relation 2n=m is satisfied. The display control logic circuit 15 outputs a first n-bit internal dump signal 1 and a second n-bit internal dump signal 2 to the second selector 16.

The display control logic circuit 15 outputs a select signal to the second selector 16. When the select signal is at High level, the first n-bit internal dump signal 1 is output to the internal dump signal line 18. When the select signal is at Low level, the second n-bit internal dump signal 2 is output to the internal dump signal line 18.

Thus, the addition of the second selector 17 makes it possible to increase the number of internal dump signals to be extracted. Therefore, the test can be performed using the internal dump signals in the plurality of internal logic circuits that are provided in the display control logic circuit 15, thereby improving the observability of each internal logic circuit.

As described above, according to exemplary embodiments of the present invention, a test circuit can be implemented only by adding the first selector 13 to the display drive control LSI. Further, a plurality of driver circuits can be tested at one time, which results in a reduction in test time. Furthermore, the addition of the second selector 16 makes it possible to improve the observability of each internal logic circuit.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A display driving circuit comprising:
a plurality of driver circuits;
a control circuit that controls the plurality of driver circuits; and
a first selector that selects one of a video input signal externally received and an internal operation signal from the control circuit, and supplies the selected signal to each of the plurality of driver circuits.

2. The display driving circuit according to claim 1, wherein the selector supplies the video input signal to each of the plurality of driver circuits during a normal operation, and supplies the internal operation signal from the control circuit to each of the plurality of driver circuits during a test mode.

3. The display driving circuit according to claim 1, wherein
each of the plurality of driver circuits comprises a latch circuit, and
the latch circuit of the plurality of driver circuits sequentially holds the internal operation signal and outputs the internal operation signal at one time, during a test mode.

4. The display driving circuit according to claim 2, wherein
each of the plurality of driver circuits comprises a latch circuit, and
the latch circuit of the plurality of driver circuits sequentially holds the internal operation signal and outputs the internal operation signal at one time, during the test mode.

5. The display driving circuit according to claim 1, further comprising a second selector that outputs part of the internal operation signal to the first selector.

6. The display driving circuit according to claim 2, further comprising a second selector that outputs part of the internal operation signal to the first selector.

7. The display driving circuit according to claim 3, further comprising a second selector that outputs part of the internal operation signal to the first selector.

8. The display driving circuit according to claim 4, further comprising a second selector that outputs part of the internal operation signal to the first selector.

9. A test method for a display driving circuit comprising a plurality of driver circuits and a control circuit that controls the plurality of driver circuits, the method comprising:
supplying a video input signal externally received to each of the plurality of driver circuits through a selector, during a normal operation; and
switching the video input signal to an internal operation signal of the control circuit, and supplying the internal operation signal to each of the plurality of driver circuits through the selector, during a test mode.

10. The test method according to claim 9, wherein, during the test mode, the internal operation signal is sequentially held in a latch circuit provided in each of the plurality of driver circuits, and is output at one time.

11. The test method according to claim 9, wherein part of the internal operation signal is output to the selector.

12. The test method according to claim 10, wherein part of the internal operation signal is output to the selector.
